(19) United States
(12) Patent Application Publication
(10) Pub. No.: US 2026/0026485 A1
(43) Pub. Date: Jan. 29, 2026

(54) FISHING REEL

(71) Applicant: Shimano Inc., Sakai City (JP)

(72) Inventors: Takeshi IKUTA, Sakai City (JP); Kohei Nakamura, Sakai City (JP); Hirotaka Honda, Sakai City (JP); Hiroki OOGOSE, Sakai City (JP)

(21) Appl. No.: 19/215,978

(22) Filed: May 22, 2025

(30) Foreign Application Priority Data
Jul. 26, 2024 (JP) 2024-121240

(51) Int. Cl. A01K 89/015; A01K 89/00

(52) U.S. Cl. CPC A01K 89/0183; A01K 89/006

(57) ABSTRACT

A fishing reel in which a maximum drag force can be increased as needed while the size of the reel is kept from increasing includes: a reel body; a handle rotatably mounted on the reel body; a drive shaft configured to rotate integrally with the handle; a spool rotatably supported by the reel body; a drive gear configured to rotate integrally with the spool; a first drag mechanism for restricting relative rotation between the drive shaft and the drive gear; a spool shaft configured to rotate integrally with the spool; a second drag mechanism configured to restrict relative rotation between the spool shaft and the reel body; and a restriction switching mechanism configured to switch the second drag mechanism between a restricted state and a non-restricted state.

### CROSS-REFERENCE TO RELATED APPLICATIONS

This application claims priority to Japanese Patent Application No. 2024-121240, filed Jul. 26, 2024. The contents of that application are incorporated by reference herein in their entirety.

### TECHNICAL FIELD

The present invention relates to a fishing reel.

### BACKGROUND ART

Conventionally, a fishing reel includes a reel body, a handle rotatably mounted on the reel body, a drive shaft configured to rotate integrally with the handle, a spool rotatably supported by the reel body, a drive gear configured to rotate integrally with the spool, a drag mechanism for restricting relative rotation between the drive shaft and the drive gear, and a spool shaft configured to rotate integrally with the spool. In such configurations, the drag mechanism is incorporated in the drive-gear and shaft assembly (for example, see Japanese Patent No. 6649699).

### BRIEF SUMMARY

In a fishing reel equipped with such a drag mechanism (commonly referred to as a “star drag mechanism”), the output at the spool is reduced by the gear ratio, resulting in a lower maximum drag force compared to that of spinning reels or lever drag reels.

One possible approach to address this issue is to increase the number of drag assemblies arranged on the drive gear shaft to enhance the drag force. However, increasing the number of drag assemblies moves the handle further away from the reel body, making the reel less stable and more difficult for the user to apply force during reeling by the handle. Furthermore, an increase in drag force necessitates a corresponding increase in the strength of the roller clutch. This, in turn, requires a larger roller clutch, which increases the overall size of the reel. Accordingly, there remains room for improvement in achieving a higher drag force in a fishing reel.

Aspects of the invention relate to a fishing reel that allows addition of drag force as needed, while keeping the overall size of the reel from increasing.

According to a first aspect of a fishing reel of the claimed invention, the fishing reel includes: a reel body; a handle rotatably mounted on the reel body; a drive shaft configured to rotate integrally with the handle; a spool rotatably supported by the reel body; a drive gear configured to rotate integrally with the spool; a first drag mechanism configured to restrict relative rotation between the drive shaft and the drive gear; a spool shaft configured to rotate integrally with the spool; a second drag mechanism configured to restrict relative rotation between the spool shaft and the reel body; and a restriction switching mechanism configured to switch the second drag mechanism between a restricted state and a non-restricted state.

In the first aspect of the fishing reel described in the claimed invention, if the drag force (or braking force) applied by the first drag mechanism on the spool shaft is inadequate, a restriction switching mechanism can be employed. This mechanism switches the second drag mechanism to a non-restricted state and a restricted state, limiting the relative rotation between the spool shaft and the reel body. Consequently, the drag force from the second drag mechanism can be supplemented, in addition to the drag force from the first drag mechanism.

In a second aspect of the claimed invention, in the fishing reel according to the first aspect, the second drag mechanism includes: a first drag plate configured to rotate integrally with the spool shaft; a second drag plate arranged around the spool shaft and facing the first drag plate; and a restriction unit configured to restrict relative rotation between the first and second drag plates. The restriction switching mechanism is preferably configured to switch the second drag plate between a rotatable state and a non-rotatable state around the spool.

In this case, since the restriction switching mechanism switches the second drag plate between a rotatable state and a non-rotatable state, the drag force can be added when necessary through a relatively simple configuration.

In a third aspect of the claimed invention, in the fishing reel according to the second aspect, the second drag plate includes an engagement recess, and the restriction switching mechanism includes: a restriction-switching operation unit; and an engagement claw engageable with the engagement recess. The restriction-switching operation unit is preferably configured to engage and disengage the engagement recess and the engagement claw, so as to switch the second drag plate between a rotatable state and a non-rotatable state around the spool.

In this case, by engaging and disengaging the engagement recess of the second drag plate and the engagement claw of the restriction-switching operation unit, the second drag plate can be easily switched between a rotatable state and a non-rotatable state around the spool.

In a fourth aspect of the claimed invention, in the fishing reel according to the third aspect, the engagement recess of the second drag plate preferably has a gear shape that is configured to prohibit a first rotation in a direction in which a fishing line is dispensed and permits a second rotation in a direction in which the fishing line is retrieved.

In this case, when the second drag plate rotates in the line-retrieving direction, the gear-shaped engagement recess permits the second rotation, thereby allowing rotation of the second drag plate.

In a fifth aspect of the claimed invention, in the fishing reel according to any one of the first to fourth aspects, the fishing reel may further include an adjustment mechanism configured to adjust a restriction force applied by the second drag mechanism.

In this case, the adjustment mechanism allows adjustment of a restriction force applied by the second drag mechanism.

In a sixth aspect of the claimed invention, in the fishing reel according to the fifth aspect, the adjustment mechanism preferably includes an adjustment-switching operation unit configured to switch between an adjustable state and a non-adjustable state.

In this case, by operating the adjustment-switching operation unit, the adjustment mechanism can be easily switched between the adjustable state and the non-adjustable state, thereby allowing the restriction force to be adjusted.

In a seventh aspect of the present invention, in the fishing reel according to the fifth aspect, the second drag mechanism preferably includes a first drag plate configured to rotate integrally with the spool shaft, a second drag plate arranged facing the first drag plate, and a restriction unit configured to apply a restriction force to the relative rotation between the first drag plate and the second drag plate. The adjustment mechanism preferably includes an adjustment unit configured to adjust the restriction force applied by the restriction unit.

In this case, the restriction force applied by the restriction unit can be adjusted by the adjustment unit, thereby allowing adjustment of the restriction force applied by the second drag mechanism.

In an eighth aspect of the present invention, in the fishing reel according to the seventh aspect, the second drag mechanism may further include a switching device disposed in the reel body and configured to selectively connect or disconnect rotation between an outer peripheral gear of the second drag plate, the rotation of which is restricted, and a gear configured to rotate integrally with the spool shaft.

In this case, the switching device in the reel body can be used to selectively connect or disconnect the rotation between the outer peripheral gear of the second drag plate, the rotation of which is restricted, and a gear configured to rotate integrally with the spool shaft.

In a ninth aspect of the present invention, in the fishing reel according to the seventh aspect, the adjustment unit preferably includes an adjustment knob disposed on the reel body and an adjustment gear arranged around the axis of the spool. The adjustment gear is configured to advance and retract in the axial direction of the spool shaft by operation of the adjustment knob so as to adjust the restriction force applied by the restriction unit.

In this case, operation of the adjustment knob causes the adjustment gear, which moves forward and backward in the axial direction of the spool shaft, to adjust the restriction force applied by the restriction unit to restrict the relative rotation between the first drag plate and the second drag plate.

According to the fishing reel of the claimed invention, a fishing reel is provided in which a drag force can be added as needed, while keeping the overall size of the reel from increasing. Other aspects, features, and advantages of the claimed invention will be set forth in the description that follows.

### BRIEF DESCRIPTION OF THE DRAWINGS

FIG. 1 is a perspective view of a dual-bearing reel according to a first embodiment of the claimed invention.

FIG. 2 is a cross-sectional view illustrating the dual-bearing reel of FIG. 1.

FIG. 3 is an exploded perspective view illustrating a portion of a second drag mechanism.

FIG. 4 is a side view of the second drag mechanism as viewed axially from the right.

FIG. 5 is a side view, taken along line I-I in FIG. 2, illustrating a portion of the second drag mechanism as viewed axially from the left.

FIG. 6 is a side view, taken along line I-I in FIG. 2, illustrating a portion of the second drag mechanism as viewed axially from the right.

FIG. 7 is a cross-sectional view of a dual-bearing reel according to a second embodiment.

FIG. 8 is a side view of the dual-bearing reel illustrated in FIG. 7, as viewed axially from the left.

FIG. 9 is a perspective view illustrating the configuration of a second drag mechanism of the dual-bearing reel of FIG. 7.

FIG. 10 is a cross-sectional view illustrating the main portion of an adjustment mechanism of the second drag mechanism.

FIG. 11 is a cross-sectional view illustrating the second drag mechanism of a dual-bearing reel according to a third embodiment.

FIG. 12 is a side view of the dual-bearing reel illustrated in FIG. 11, as viewed axially from the left.

FIG. 13 is a perspective view of the dual-bearing reel illustrated in FIG. 12, with the left cover member and each operation unit omitted.

FIG. 14 is a side view of the second drag mechanism as viewed axially from the right.

FIGS. 15A and 15B are diagrams illustrating the operation of the switching device of the second drag mechanism in FIG. 14: FIG. 15A illustrates the disconnected state; and FIG. 15B illustrates the connected state.

FIG. 16 is a cross-sectional view illustrating the main components of a second drag mechanism and an adjustment mechanism for adjusting the drag force in a third embodiment.

### DETAILED DESCRIPTION

Embodiments of a fishing reel according to the claimed invention will be described below with reference to the drawings. It should be noted that in the drawings, the scale of each component may be adjusted as necessary so that each component can be visibly recognized. In the present embodiment, a dual-bearing fishing reel is described using a dual-bearing reel as an example.

### (Overall Configuration)

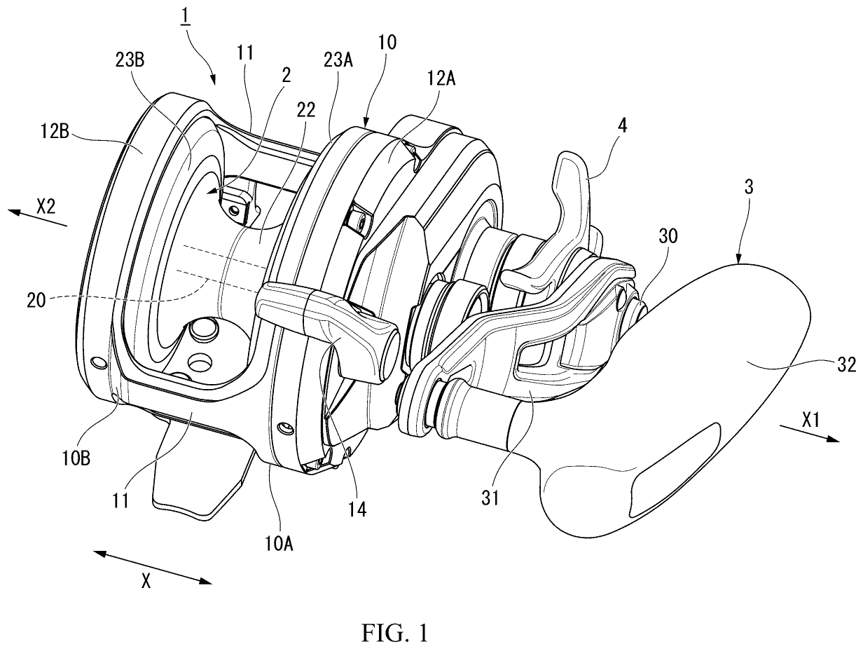

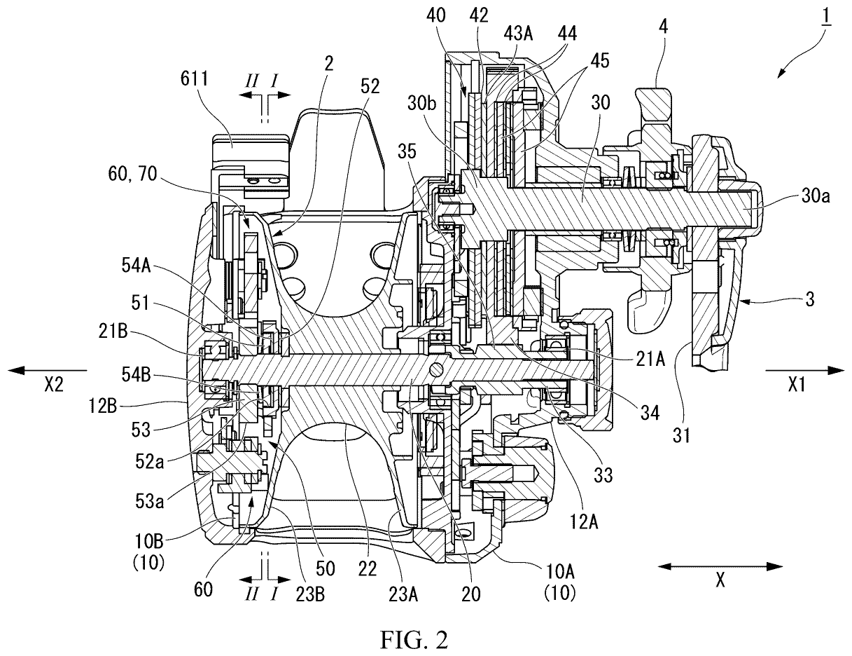

As illustrated in FIGS. 1 and 2, the fishing reel of the present embodiment is implemented as a dual-bearing reel 1 capable of winding a fishing line.

The dual-bearing reel 1 includes a reel body 10, a spool shaft 20 rotatably mounted at the center of the reel body 10, a spool 2 non-rotatably supported on the spool shaft 20, a handle 3 disposed on a side of the reel body 10, and a drag adjustment unit 4 for drag adjustment that is arranged on a side of the handle 3 toward the reel body 10.

This description uses the terms “drag force” and “braking force” to refer to forces applied to the spool shaft 20. The term “restriction force” is used to describe a force created within the drag adjustment unit 4 that results in increased drag force, as will be described below in more detail. The terms “restriction” and “restriction force” are used uniformly in the claims.

As illustrated in FIG. 2, the reel body 10 of the dual-bearing reel 1 transmits rotation of the handle 3 to the spool 2 in a direction in which a fishing line is retrieved via a drive gear 34 and a pinion gear 35. The reel body 10 also includes drag mechanisms 40 and 50 for applying drag force to the rotation of the spool 2 in a direction in which the fishing line is dispensed.

### (Reel Body)

The reel body 10 includes: a pair of right and left plate frames 10A and 10B, both being formed of metal; a plurality of connecting frames 11 connecting the right and left plate frames 10A and 10B at the front, rear, and bottom thereof; and cover members 12A and 12B covering the outer sides of the right side plate frame 10A and the left side plate frame 10B, respectively.

The connecting frame 11 located at the lower side is integrally formed with a rod mounting portion 13 to attach the dual-bearing reel 1 to a fishing rod. The right plate frame 10A, the left plate frame 10B, and the connecting frames 11 are integrally formed by metal cutting processes.

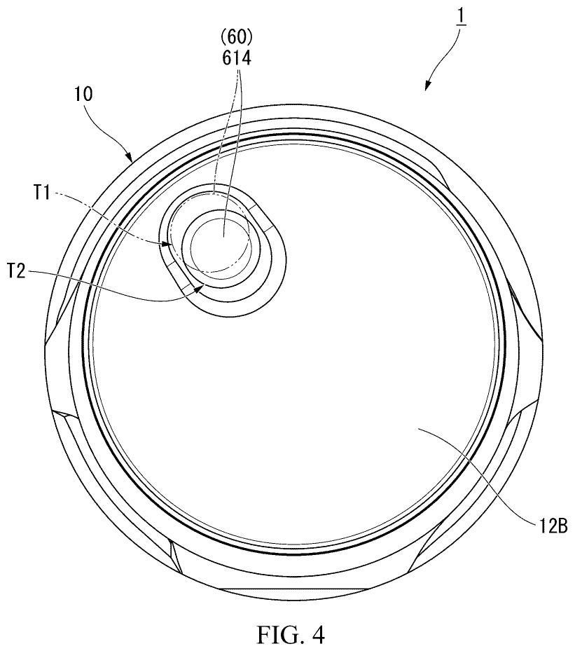

As illustrated in FIG. 1, the right cover member 12A covers the outer side of the right plate frame 10A. In addition, the right plate frame 10A and the left plate frame 10B each have an opening through which the spool 2 passes. The left cover member 12B (see FIG. 4) rotatably supports the left end of the spool shaft 20.

As illustrated in FIG. 2, a first housing space S1 is defined inside the right plate frame 10A and accommodates a rotation transmission mechanism 30A for transmitting rotation of the handle 3 to the spool 2. The first housing space S1 further accommodates a clutch control mechanism (not illustrated) for controlling a clutch mechanism in response to the operation of a clutch operation unit 14 (illustrated in FIG. 1), and a first drag mechanism 40 (described later). A second housing space S2 is defined inside the left side plate frame 10B and accommodates a second drag mechanism 50 (described later) therein.

### (Spool Shaft)

As illustrated in FIG. 2, the spool shaft 20 is rotatably supported by the right and left cover members 12A and 12B. The spool shaft 20 is rotatably supported by first and second bearings 21A and 21B that are arranged on the outer circumferential surface thereof. The spool shaft 20 is integrally fixed to the spool 2.

### (Spool)

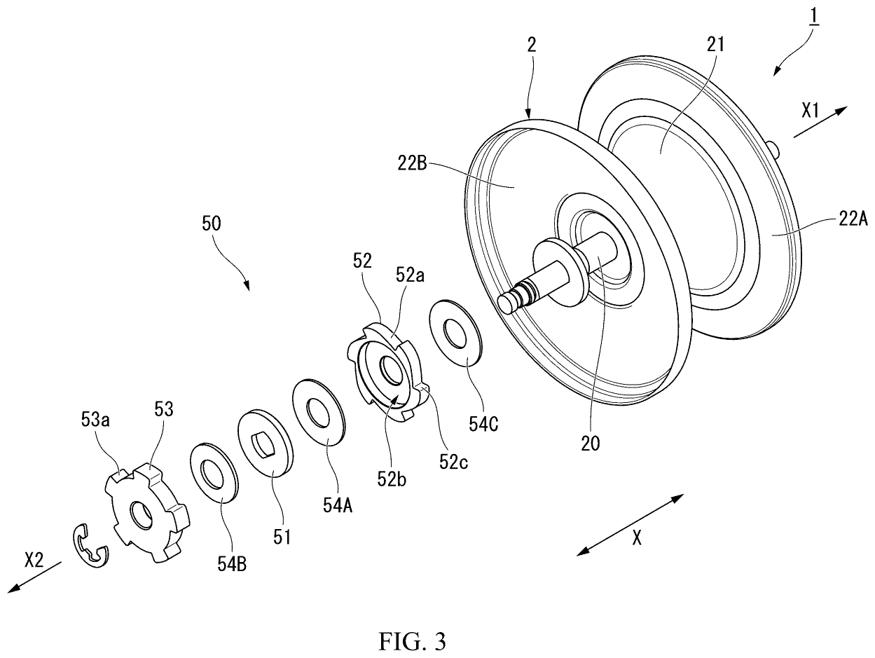

As illustrated in FIGS. 2 and 3, the spool 2 includes a spool barrel portion 22 and a pair of flanges 23 integrally formed at both ends of the spool barrel portion 22.

### (Handle)

As illustrated in FIGS. 1 and 2, a drive shaft 30, which serves as the rotation axis of the handle 3, is disposed in front of and parallel to the spool shaft 20. The handle 3 is fixed to the projecting end of the drive shaft 30 and rotates integrally with the drive shaft 30. The drive shaft 30 is rotatably supported by the reel body 10. The handle 3 includes a handle arm 31 extending in a direction intersecting the drive shaft 30, and a handle grip 32 rotatably mounted at the distal end of the handle arm 31. The handle arm 31 is a plate metal member and has a non-circular through-hole located at the proximal end thereof, through which the drive shaft 30 is rotatably integrally mounted.

### (Rotation Transmission Mechanism)

The rotation transmission mechanism 30A includes a mechanism for transmitting a first rotation in the line-retrieving direction of the handle 3 to the spool 2, and a clutch mechanism for switching on and off the transmission of the first rotation in the line-retrieving direction from the spool 2 to the handle 3.

The rotation transmission mechanism 30A includes a pinion gear shaft 33 detachably connected to the spool shaft 20, a drive shaft 30 to which the handle 3 is fixed, a drive gear 34 connected to the drive shaft 30, and a pinion gear 35 mounted to the pinion gear shaft 33 to mesh with the drive gear 34.

The pinion gear shaft 33 is externally fitted onto the spool shaft 20 and engages with the spool shaft 20 of the spool 2. The spool shaft 20 is inserted through a through-hole 33a of the pinion gear shaft 33. The pinion gear shaft 33 is axially movable forward and backward relative to the spool shaft 20 by an on/off switching operation of the clutch mechanism, so that the pinion gear shaft 33 can be connected with or disconnected from the spool shaft 20 by the movement in the axial direction. In the connected state, the pinion gear shaft 33 rotates integrally with the spool shaft 20. That is, rotation of the handle 3 is transmitted via the rotation transmission mechanism 30A, and the spool 2 is caused to rotate in the line-retrieving direction.

The drive shaft 30 is disposed inside the right plate frame 10A. The drive shaft 30 extends in the left-right direction, passes through the right cover member 12A in the axial direction. At the projecting end of the drive shaft 30, the drag adjustment unit 4 and the handle 3 are mounted. The drive shaft 30 corresponds to a handle shaft and is arranged in the left-right direction, that is, parallel to the axial direction of the spool 2.

The drive shaft 30 is connected to the handle 3 and is rotatably supported with respect to the right plate frame 10A. The drive shaft 30 has a drive gear 34 mounted thereto. In addition, drag washers and flat washers are also mounted to the drive shaft 30. The washers are composed of multiple thin metal plates and stacked in the axial direction to constitute the first drag mechanism 40.

The drive gear 34 is connected such that it rotates integrally in the direction X2 of the drive shaft 30 via the pinion gear 35 when the fishing line is pulled in the line-dispensing direction with a force equal to or less than the drag force. When the fishing line is pulled in the line-dispensing direction with a force exceeding the drag force, the drive shaft 30 is allowed to relatively rotate via the pinion gear 35. The drive gear 34 has teeth on its outer circumference that mesh with the pinion gear 35.

The pinion gear 35 has outer gear teeth that mesh with the drive gear 34.

During manual winding of the dual-bearing reel 1 configured as described above, with the clutch being connected, the first rotation of the handle 3 in the line-retrieving direction is transmitted to the spool 2 in the following sequence: handle 3, drive shaft 30, first drag mechanism 40 (and second drag mechanism 50), drive gear 34, pinion gear 35, pinion gear shaft 33, and spool 2. At this time, the rotational power from the handle 3 is transmitted to the spool 2 by the frictional force generated by the drag washers and other components constituting the drag mechanism 40, thereby producing the drag function.

The drag mechanism includes: a first drag mechanism 40 for restricting relative rotation between the drive shaft 30 and the drive gear 34; a second drag mechanism 50 for restricting relative rotation between the spool shaft 20 and the reel body 10; and a drag switching mechanism 60 for switching the second drag mechanism 50 between a restricted state and a non-restricted state.

### (First Drag Mechanism)

As illustrated in FIG. 2, the first drag mechanism 40 includes a stopper gear 42, a first drag washer 43, and the drive gear 34, which are arranged in this order in an axially stacked state from the base end 30b of the drive shaft 30 in the direction X2 toward the distal end 30a of the drive shaft 30 in the direction X1. Furthermore, to the right of the drive gear 34 in the direction X1, a plurality of second drag washers 44 and a plurality of flat washers 45 are arranged in an axially stacked state. The stopper gear 42 and the flat washers 45 are non-rotatably mounted to the drive shaft 30.

In the first drag mechanism 40, the rotational power from the handle 3 is transmitted to the spool 2 by the frictional force generated on both sliding surfaces of each drag washer 43 and 44, thereby producing drag performance. In the dual-bearing reel 1, when the clutch is connected, the rotational power from the handle 3 is transmitted to the spool 2 in the following sequence: handle 3, drive shaft 30, drag washers 43 and 44, drive gear 34, pinion gear 35, pinion gear shaft 33, spool shaft 20, and spool 2.

When the fishing line is strongly pulled in the line-dispensing direction, a force exceeding the drag force acts on the drive gear 34, and thus the force is applied to the spool 2, pinion gear 35, and drive gear 34 in this sequence. At this time, slippage occurs between the drive gear 34, drag washers 43 and 44, stopper gear 42, and flat washers 45, which allows the fishing line to be dispensed.

### (Second Drag Mechanism)

As illustrated in FIG. 2, the second drag mechanism 50 is configured to supplement the drag force generated by the first drag mechanism 40 by adding additional drag force.

The second drag mechanism 50 includes a main drag plate 51 (first drag plate), a drag receiving gear 52 (second drag plate) arranged relative to the spool shaft 20 to face the main drag plate 51, and a drag nut 53 (restriction unit) for restricting relative rotation between the main drag plate 51 and the drag receiving gear 52. The main drag plate 51, drag receiving gear 52, and drag nut 53 are coaxially arranged with the spool shaft 20.

As illustrated in FIG. 3, the main drag plate 51 is a disc-shaped braking disk made of metal such as stainless steel and is arranged between the drag receiving gear 52 and the drag nut 53. Specifically, a washer 54A made of carbon-reinforced fiber or similar material is interposed between the main drag plate 51 and the drag receiving gear 52, and a metallic disc spring 54B is interposed between the main drag plate 51 and the drag nut 53. The main drag plate 51 is non-rotatably fixed to the spool shaft 20 and rotates integrally with the spool shaft 20. The main drag plate 51 generates and adjusts a drag force in the axial direction X of the spool shaft 20 between the main drag plate 51 and the drag receiving gear 52 by moving the drag nut 53 forward or backward in the axial direction and adjusting the tightening relative to the spool shaft 20.

The drag receiving gear 52 is a disc-shaped braking disk made of stainless steel. The surface of the drag receiving gear 52 facing in the direction X2 includes, at the central portion, a receiving recess 52b that is recessed inward in the axial direction (the direction X1) when viewed in plan view along the axial direction X of the spool shaft 20. The main drag plate 51 is coaxially arranged in the receiving recess 52b of the drag receiving gear 52. The bottom surface of the receiving recess 52b (which corresponds to the plate surface of the drag receiving gear 52) is in contact with the main drag plate 51 via a first carbon washer 54A. The right side of the drag receiving gear 52 is in contact via a second carbon washer 54C.

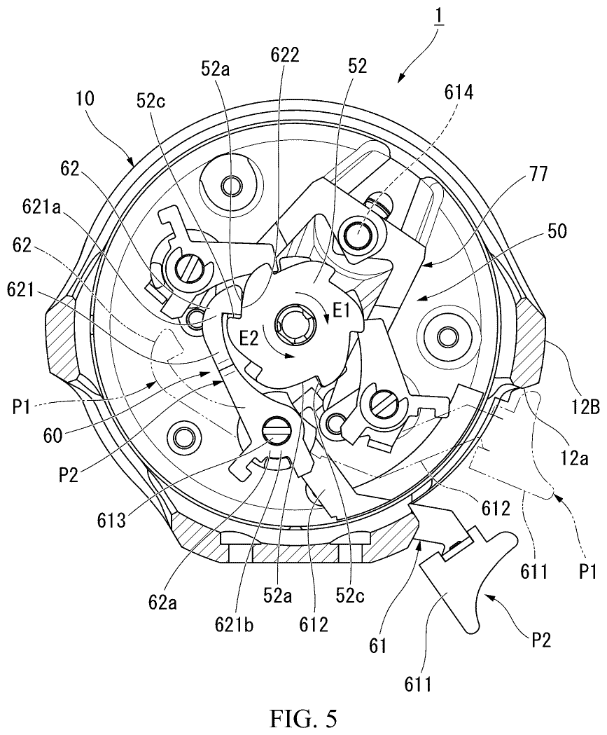

As illustrated in FIGS. 3 and 5, the drag receiving gear 52 includes a plurality of engagement recesses 52a arranged circumferentially on the outer circumferential portion thereof. Each engagement recess 52a includes an engagement surface 52c facing in a second rotational direction E2 opposite a first rotational direction E1 which is one of the rotation directions. One of the engagement recesses 52a is engaged with an engagement claw 62 of the restriction switching mechanism 60 for restricting the rotation of the drag receiving gear 52 in the first direction E1 (first rotation). That is, when the drag receiving gear 52 rotates in the first direction E1 (first rotation), the engagement claw 62 engages one of the engagement recesses 52a and abuts the engagement surface 52c. As a result, the rotation of the drag receiving gear 52 (first rotation) is restricted and stopped. In contrast, when the drag receiving gear 52 rotates in the second direction E2 (second rotation), the engagement recesses 52a ride over the engagement claw 62 and rotate, allowing the drag receiving gear 52 to rotate in the second direction E2. In other words, the engagement recesses 52a of the drag receiving gear 52 have a gear shape that allows the second rotation in the line-retrieving direction.

The drag nut 53 is threadably engaged to the spool shaft 20 and arranged to the left of the main drag plate 51 in the direction X2, so as to be rotatable and movable relative to the spool shaft 20. The drag nut 53 is tightened by threaded engagement, and rotating the nut 53 causes it to move axially in the direction X1. As the drag nut 53 moves in the direction X1, it presses the main drag plate 51 from the direction X2, restricting relative rotation between the main drag plate 51 and the drag receiving gear 52 and generating frictional force therebetween. The drag force is adjusted by controlling the advancement or retraction of the drag nut 53 in the axial direction X.

### (Restriction Switching Mechanism)

As illustrated in FIG. 5, the restriction switching mechanism 60 includes a restriction-switching operation unit 61 and an engagement claw 62 that is engageable with the engagement recesses 52a of the drag receiving gear 52. The restriction switching mechanism 60 is configured to selectively engage or disengage the engagement claw 62 with one of the engagement recesses 52a by operating the restriction-switching operation unit 61, thereby switching the drag receiving gear 52 between a rotatable state and a non-rotatable state around the spool 2.

The restriction-switching operation unit 61 is connected to the engagement claw 62 and interlocked so as to selectively move the engagement claw 62 into or out of engagement with the engagement recesses 52a by operation. The restriction-switching operation unit 61 includes an operation body 611, a connecting piece 612 extending from the operation body 611, and a support shaft 613 rotatably supporting one end of the connecting piece 612 and an end portion 62a of the engagement claw 62.

More specifically, as illustrated in FIG. 5, when the restriction-switching operation unit 61 is moved from the disengaged position P1 (indicated by the two-dot chain line in FIG. 5) to the engaged position P2 (indicated by the solid line in FIG. 5), one end of the connecting piece 612 of the engagement claw 62 at the end portion 62a pivots about the support shaft 613. As a result, the locking claw 622 at the tip 621a of the end portion 62a of the engagement claw 62 engages with one of the engagement recesses 52a of the drag receiving gear 52, thereby restricting the rotation of the drag receiving gear 52 in the first direction E1, i.e., the direction in which the fishing line is dispensed.

As described above, the drag receiving gear 52 generates a frictional force against the carbon washer, the frictional force being adjusted by moving the drag nut 53 forward or backward along the axial direction X with respect to the spool shaft 20.

In this way, when the restriction switching mechanism 60 is operated to switch between the restricted and unrestricted states of the second drag mechanism 50, the second drag mechanism 50 is caused to add supplementary drag force to the drag force generated by the first drag mechanism 40.

The operation body 611 is fixed to the other end of the connecting piece 612 and protrudes outward from the opening 12b of the left cover member 12B to be operable. As illustrated in FIG. 2, the operation body 611 is positioned forward of the left cover member 12B of the reel body 10, that is, located in the direction X2 (facing the handle 3) from the axial center of the spool. The operation body 611 in this position secures a thumbing space on the handle 3 side (in the direction X1) from the center of the spool shaft direction, which facilitates thumbing and improves usability.

As described above, when the drag force from the first drag mechanism 40 against the spool shaft 20 is insufficient, switching to the restricted state via the restriction switching mechanism 60 enables restriction of the relative rotation between the spool shaft 20 and the reel body 10 by the second drag mechanism 50, thereby allowing supplemental drag force to be added from the second drag mechanism 50 to that from the first drag mechanism 40. That is, in the present embodiment, the maximum drag force can be increased as needed by the combined forces from the first drag mechanism 40 and the second drag mechanism 50. Furthermore, the drag force from the second drag mechanism 50 becomes unlikely to cause damage to conventional stoppers or gears.

The drag force added or supplemented by the second drag mechanism 50 is adjusted by the relative position between the drag nut 53 and the spool shaft 20 via threaded engagement. Therefore, a configuration is possible in which the spool 2 is removed together with the second drag mechanism 50 from the reel body 10, the drag nut 53 is adjusted, and then all these are reassembled into the reel body 10. However, in the present embodiment, an adjustment mechanism 70 is provided that is configured to adjust the drag force added or supplemented by the second drag mechanism 50 without removing the spool 2 and the second drag mechanism 50 from the reel body 10.

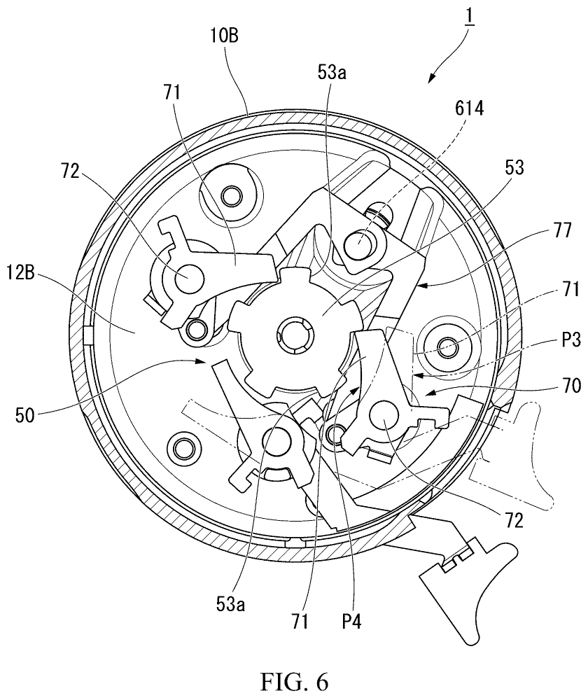

In the adjustment mechanism 70 illustrated in FIG. 6, when the operation unit 614 (see FIG. 4) of the restriction switching mechanism 60 is operated to switch to the restricted position T1 (indicated by the two-dot chain line in FIG. 4), a link mechanism 77 causes a locking claw 71 to pivot about the shaft 72 and engage with a gear unit 53a, which has multiple teeth arranged in the circumferential direction on the outer peripheral surface of the drag nut 53. At this time, the operation unit 614 is situated at the restricted position, which makes the drag nut 53 non-rotatable with respect to the reel body 10 (left cover member 12B) due to the engagement with the locking claw 71. It should be noted that the solid line in FIG. 4 represents a restriction release position T2 of the operation unit 614.

When the drag nut 53 is in a non-rotatable state with respect to the left cover member 12B, rotation of the spool 2 together with the spool shaft 20 causes relative rotation between the drag nut 53 and the spool shaft 20 due to threaded engagement. As a result, the drag nut 53 moves relative to the spool shaft 20 in the axial direction X, allowing adjustment of the frictional force against the drag receiver 52. For example, when the operation unit 614 is operated to switch to the restricted position T1 as illustrated in FIG. 4, and the spool 2 is rotated in the line-dispensing direction, the drag nut 53 moves axially in the direction X1 with respect to the spool shaft 20, thereby increasing the drag force to be added or supplemented by the second drag mechanism 50. Conversely, rotation of the spool 2 in the line-retrieving direction causes the drag nut 53 to move axially in the direction X2, thereby achieving an adjustment such that the drag force to be added or supplemented by the second drag mechanism 50 is reduced.

In the dual-bearing reel 1 of the first embodiment configured as described above, it is possible to increase the maximum drag force as needed while keeping the reel size from increasing.

### Second Embodiment

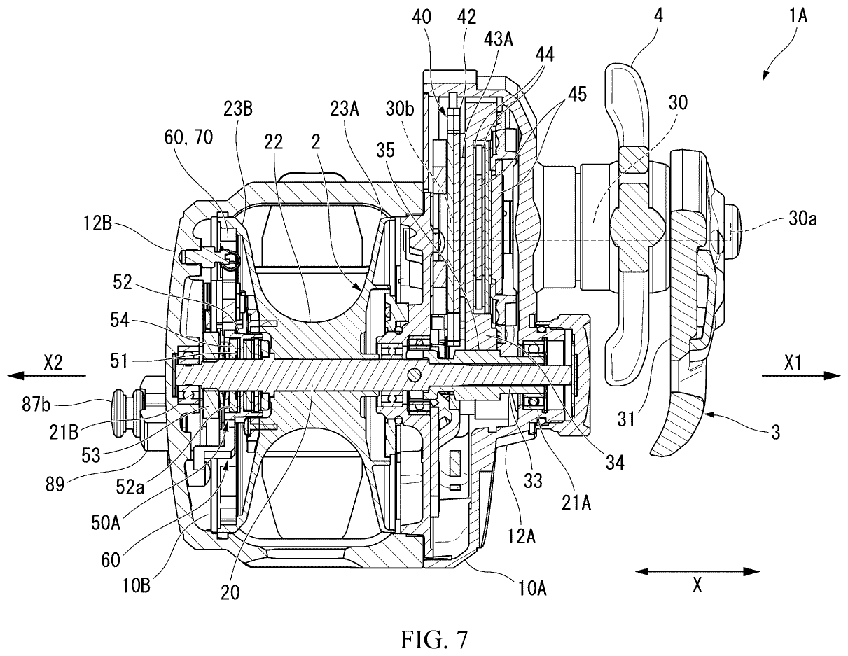

A dual-bearing reel 1A (fishing reel) according to a second embodiment illustrated in FIGS. 7 to 10 includes a second drag mechanism 50A which includes a second braking force adjustment unit 80A (adjustment unit).

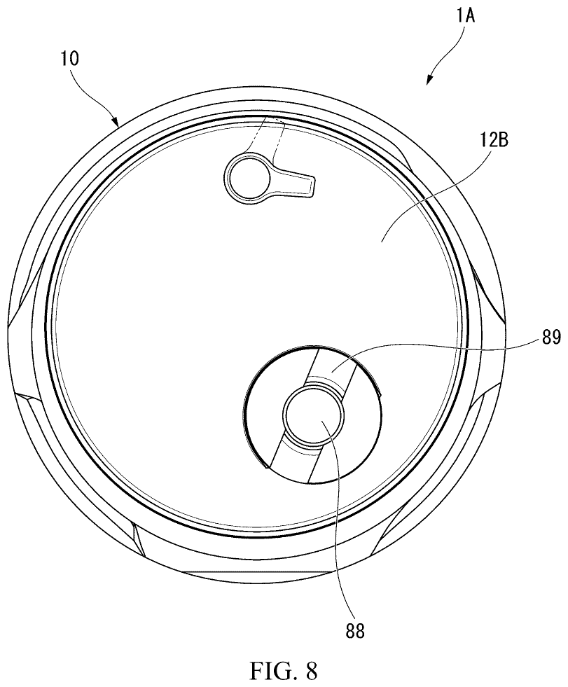

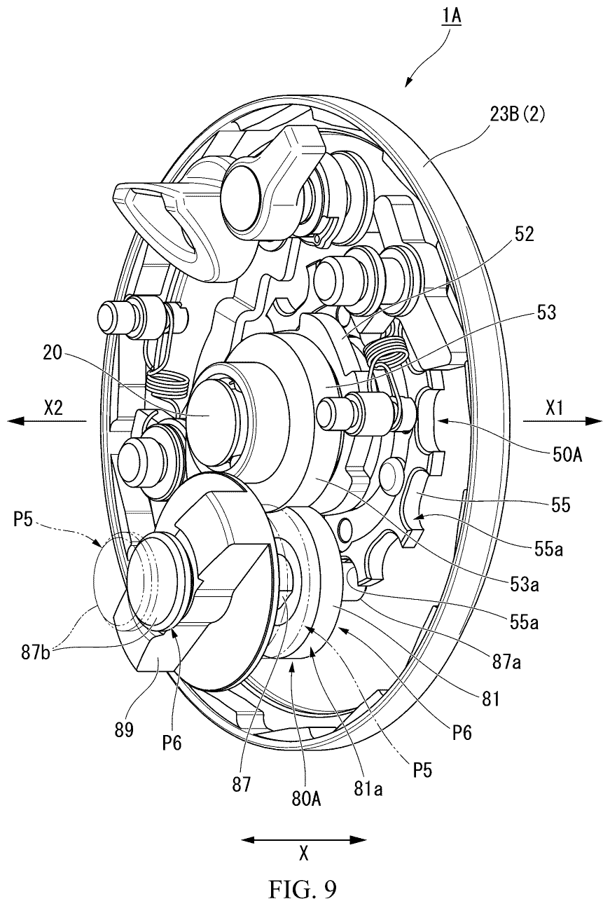

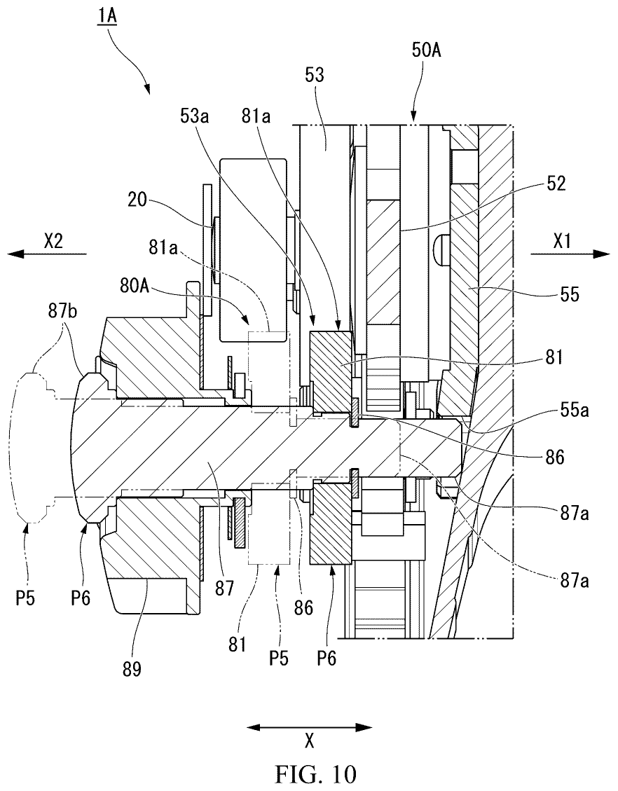

FIG. 7 is a cross-sectional view of the dual-bearing reel 1A according to the second embodiment. FIG. 8 is a side view of the dual-bearing reel 1A illustrated in FIG. 7, viewed from the axial left. FIG. 9 is a perspective view of a configuration of the second drag mechanism 50A of the dual-bearing reel 1A illustrated in FIG. 7. FIG. 10 is a cross-sectional view of the main components of the adjustment mechanism of the second drag mechanism 50A.

In the dual-bearing reel 1 of the first embodiment described above, the drag nut 53 is set in a non-rotatable state relative to the reel body 10 (left cover member 12B), and the spool shaft 20 is rotated relative to it, thereby causing the drag nut 53 to move forward and backward along the spool shaft 20 to adjust the added or supplemented drag force. In contrast, as illustrated in FIG. 7, the dual-bearing reel 1A of the second embodiment mainly differs from the dual-bearing reel 1 of the first embodiment in that the rotation of the spool shaft 20 is restricted, allowing the drag nut 53 to rotate relative to it and thereby move forward and backward along the spool shaft 20, and also in that an adjustment knob 89 (see FIG. 8) is placed on the left cover member 12B for adjusting drag force.

The basic configuration of the second drag mechanism 50A is similar to that in the first embodiment, and therefore, a detailed description is omitted here.

The dual-bearing reel 1A of the second embodiment will now be described in detail.

As illustrated in FIGS. 9 and 10, the second braking force adjustment unit 80A includes: an adjustment shaft 87 that is movable in the axial direction X; an adjustment gear 81 disposed on the adjustment shaft 87 and configured to rotate integrally therewith; an adjustment knob 89 for rotating the adjustment gear; and a lock gear 55 configured to rotate integrally with the spool shaft 20.

The adjustment shaft 87 extends in the axial direction X, parallel to the spool shaft 20. The left end 87b of the adjustment shaft 87 is locked to the left side of the adjustment knob 89. The right end of the adjustment shaft 87 includes a rotation locking unit 87a. The rotation locking unit 87a is configured to be non-rotatable relative to the spool shaft 20 and locked to the gear unit 55a of the lock gear 55.

The adjustment gear 81 is arranged to be rotatable integrally with the adjustment shaft 87. The adjustment gear 81 is arranged to be non-movable relative to the adjustment shaft 87 in the axial direction X by a retaining ring 86. The adjustment gear 81 is movable in the axial direction X together with the adjustment shaft 87 between a disengaged position P5 and an engaged position P6 relative to the drag nut 53 (restriction unit). Furthermore, the adjustment gear 81 includes a gear unit 81a on its outer circumferential surface. In the engaged position P6, the gear unit 81a of the adjustment gear 81 engages with the gear unit 53a of the drag nut 53.

The adjustment knob 89 is disposed on the left cover member 12B (see FIG. 8) such that the adjustment shaft 87 is locked to be axially movable and rotationally adjustable.

It should be noted that the adjustment shaft 87 is biased from the engaged position P6 toward the disengaged position P5 against the adjustment knob 89 by a biasing member such as a spring (not illustrated).

The lock gear 55 is mounted on the left surface of the flange portion 23B located to the left of the spool 2 in the direction X2 and has a gear unit 55a on its outer circumference (see FIG. 7). When the rotation locking unit 87a of the adjustment shaft 87 engages with the gear unit 55a of the lock gear 55, the rotation of the lock gear 55 is restricted, which in turn restricts rotation of the spool shaft 20.

To adjust the drag force from the second drag mechanism 50A configured as described above, the adjustment shaft 87, which is biased toward the adjustment knob 89 by a biasing member (not illustrated) to the disengaged position P5, is first moved in the axial direction X toward the engaged position P6 against the biasing force. At this time, the adjustment gear 81 moves together with the adjustment shaft 87 in the axial direction X to the engaged position P6. The gear unit 81a of the adjustment gear 81 then engages with the gear unit 53a of the drag nut 53 (restriction unit).

In this state, rotating the adjustment knob 89 causes the adjustment shaft 87 to rotate, which in turn rotates the adjustment gear 81. As the adjustment gear 81 rotates, the gear unit 53a of the drag nut 53 is rotated, thereby moving the drag nut 53 forward or backward along the spool shaft 20 in the axial direction X, which enables adjustment of the drag force.

When the adjustment shaft 87 moves to the engaged position P6, its rotation locking unit 87a engages with the gear unit 55a of the lock gear 55, thereby restricting rotation of the spool shaft 20. Accordingly, in the second drag mechanism 50A, the drag nut 53 becomes rotatable relative to the spool shaft 20. Thus, the drag nut 53 is moved forward and backward in the axial direction X relative to the spool shaft 20 to adjust the drag force to be added as needed.

### Third Embodiment

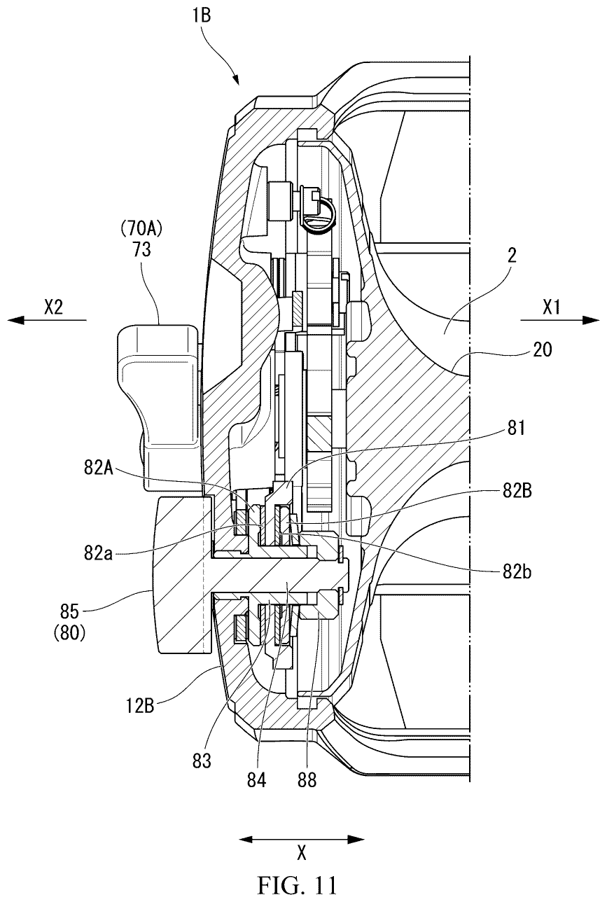

A dual-bearing reel 1B (fishing reel) according to a third embodiment illustrated in FIGS. 11 to 16 is configured such that the structures of the drag receiver 52 and drag nut 53 are incorporated in a second braking force adjustment unit 80A, unlike the first and second embodiments described above where the second drag mechanism 50A, including a drag receiver 52 and a drag nut 53, directly restricts rotation of the spool shaft 20.

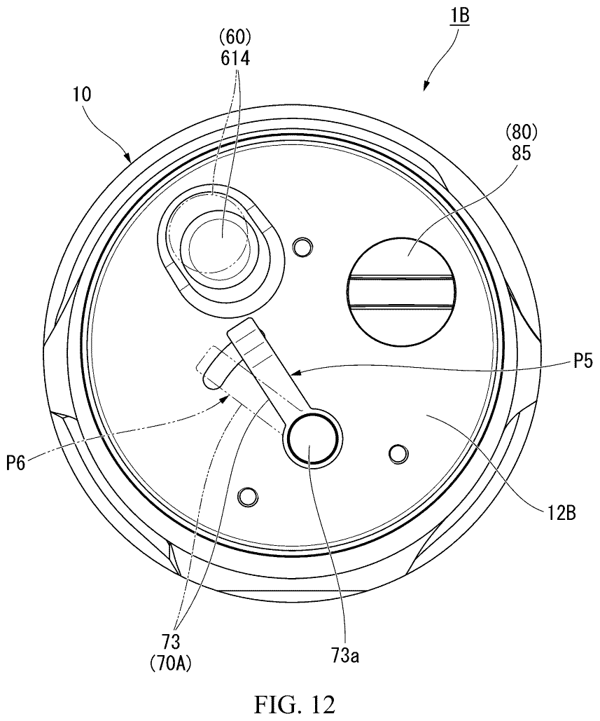

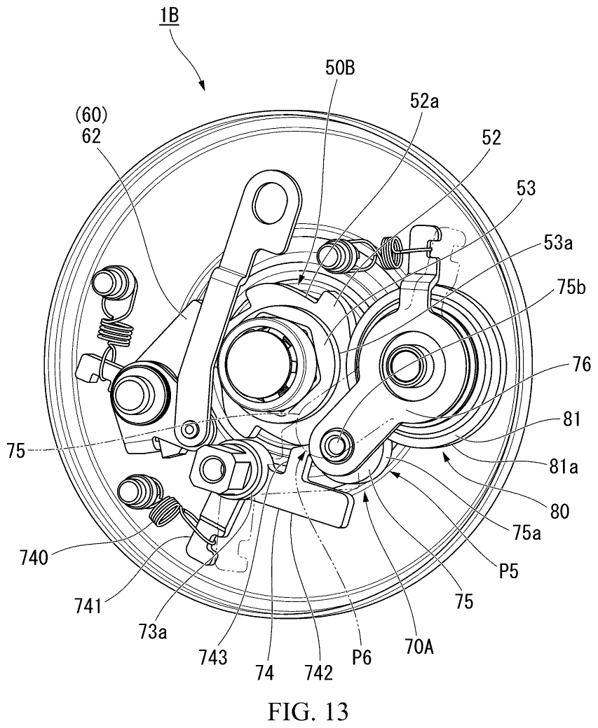

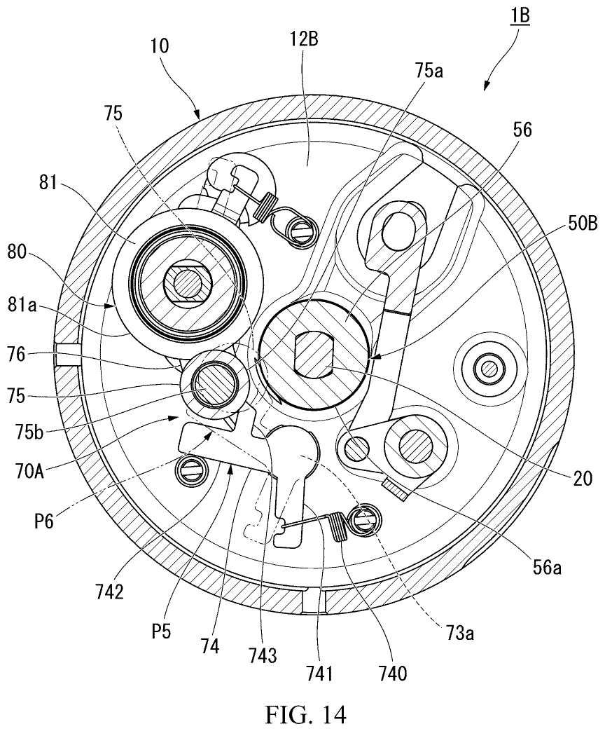

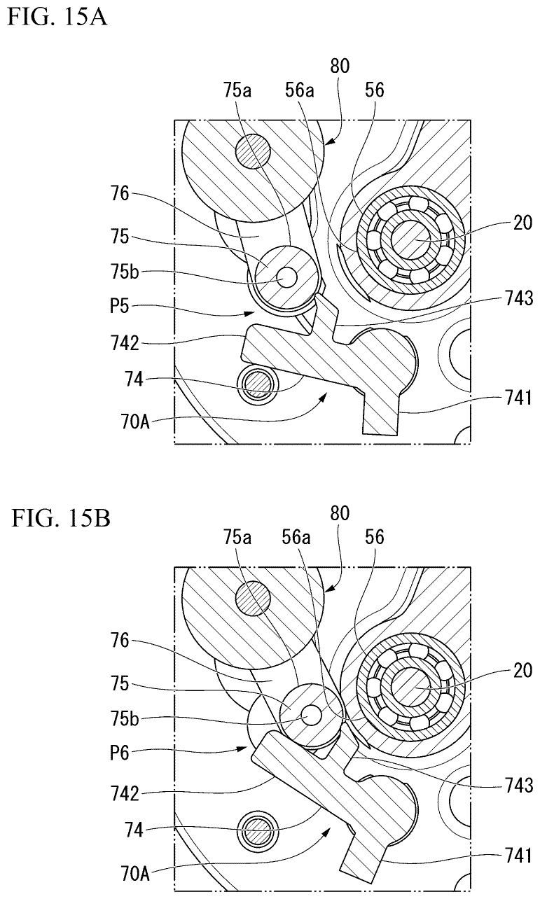

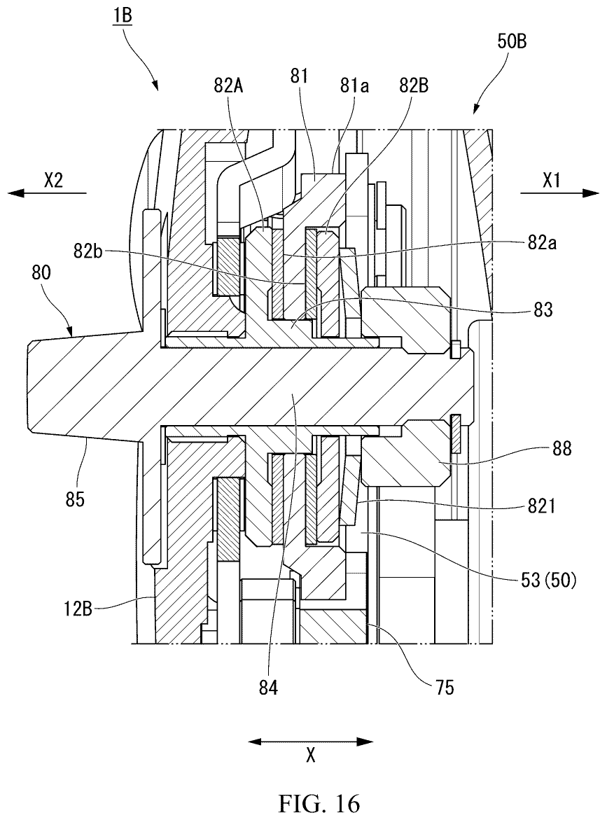

FIG. 11 is a cross-sectional view illustrating the second drag mechanism 50B of the dual-bearing reel 1B according to the third embodiment. FIG. 12 is a side view of the dual-bearing reel 1B in FIG. 11 as viewed from the direction X2. FIG. 13 is a perspective view of the reel illustrated in FIG. 12, with the left cover member 12B and operation units omitted. FIG. 14 is a diagram of the second drag mechanism 50B as viewed from the direction X1 of the axial direction X. FIGS. 15A and 15B are diagrams illustrating the operation of the switching device of the second drag mechanism in FIG. 14: FIG. 15A illustrates a disengaged position; and FIG. 15B illustrates an engaged position. FIG. 16 is a cross-sectional view illustrating the main components of the second drag mechanism 50B and the adjustment mechanism for adjusting the drag force in the third embodiment.

As illustrated in FIGS. 11 and 12, a switching operation lever 73 of the restriction switching mechanism 70A and an adjustment knob 85 are disposed on the left cover member 12B. The switching operation lever 73 is shaped to pivot about a shaft 73a. The adjustment knob 85 is shaped to be operatively rotatable about the axial direction X.

As illustrated in FIGS. 13 and 14, the restriction switching mechanism 70A of the second drag mechanism 50B according to the third embodiment includes: a switching operation lever 73 positioned on the left cover member 12B (see FIGS. 11 and 12); a movable member 74 configured to pivot integrally with the switching operation lever 73; a connecting gear 75 configured to move from a disengaged position P5 (indicated by the solid line in FIGS. 13 and 14) where it is separated from the drag nut 53 (restriction unit) to an engaged position P6 (indicated by the two-dot chain line in FIGS. 13 and 14) by the movable member 74; and a gear plate 76 rotatably supporting the connecting gear 75.

It should be noted that the meshing teeth (gears) located on the outer peripheral surfaces of the shaft gear 56, the connecting gear 75, and the adjustment gear 81 for rotating integrally with the spool shaft 20 are not illustrated in the figures.

As illustrated in FIGS. 11 and 12, the switching operation lever 73 (adjustment-switching operation unit) is biased to the disengaged position P5 (indicated by the solid line illustrated in FIG. 12). As illustrated in FIGS. 13 and 14, the movable member 74 is generally L-shaped, and a first piece 741 thereof is biased by a spring member 740 such that the movable member 74 is in the disengaged position P5. The movable member 74 also includes a second piece 742, and the central portion of the second piece 742 in the lengthwise direction includes a third piece 743 projecting toward the shaft gear 56 that rotates integrally with the spool shaft 20. The third piece 743 extends from the second piece 742 at a right angle relative to the second piece 742.

The movable member 74 is moved to switch from the disengaged position P5 illustrated in FIG. 15A to the engaged position P6 illustrated in FIG. 15B, and then the second piece 742 causes the connecting gear 75 to pivot toward engagement with the shaft gear 56. When the movable member 74 is moved to switch from the engaged position P6 back to the disengaged position P5, the third piece 743 is used to cause the connecting gear 75 to pivot away from the shaft gear 56 as illustrated in FIG. 15A.

As illustrated in FIGS. 13 and 14, the connecting gear 75 includes a gear unit 75a on its outer peripheral surface. The shaft gear 56 also includes a gear unit 56a on its outer peripheral surface. The connecting gear 75 is rotatably supported at one end of the gear plate 76 via a rotation shaft 75b. As described above, the connecting gear 75 is arranged to be switchable between the disengaged position P5 and the engaged position P6 together with the gear plate 76. At the engaged position P6, the connecting gear 75 is connected to the shaft gear 56 and rotates together with it. Furthermore, the connecting gear 75 meshes with an adjustment gear 81 of a braking force adjustment unit 80 described later. That is, rotation of the connecting gear 75, which is connected to the shaft gear 56, is transmitted to the adjustment gear 81.

With this configuration, in the second drag mechanism 50B, the switching device comprising the switching operation lever 73, the movable member 74, and the connecting gear 75 connects or disconnects the rotation between the gear unit 81a of the adjustment gear 81, which has restricted rotation, and the shaft gear 56 that rotates integrally with the spool shaft 20.

As illustrated in FIG. 16, the second drag mechanism 50B includes a braking force adjustment unit 80 (adjustment unit) for engaging with the connecting gear 75 to apply a restriction force.

The braking force adjustment unit 80 includes: the adjustment gear 81 that meshes with the connecting gear 75 (see FIGS. 13 and 14); a pair of first drag plates 82A (corresponding to the drag receiving gear 52 in the first embodiment) and a pair of second drag plates 82B (corresponding to the drag nut 53 in the first embodiment) both for applying drag force to the adjustment gear 81; a nut cylindrical portion 83 for fixing the first drag plates 82A; a shaft 84 extending parallel to the spool shaft 20 and screwed into the nut cylindrical portion 83; an adjustment knob 85 disposed on one end of the shaft 84 (end in the direction X2) for rotating the shaft 84; and an adjustment nut 88 disposed on the other end of the shaft 84 (end in the direction X1) and screwed into the nut cylindrical portion 83.

The braking force adjustment unit 80 restricts rotation of the adjustment gear 81 by sandwiching the adjustment gear 81 between a pair of washers 82a and 82b made of carbon-reinforced fibers or similar material (corresponding to the first carbon washer 54A, dish spring 54B, and second carbon washer 54C in the first embodiment) and between the pair of drag plates 82A and 82B, thereby applying friction force. In other words, the braking force adjustment unit 80 additionally or supplementally applies drag force to the rotation of the spool shaft 20 as necessary.

In the braking force adjustment unit 80, when the adjustment knob 85 is rotated, the shaft 84 and the adjustment nut 88 rotate together. The adjustment nut 88 then moves relative to the cylindrical portion 83 in the axial direction of the shaft 84. As a result, the clamping force (frictional force) of the pair of drag plates 82A and 82B is adjusted via a dish spring 821.

As described above, in the dual-bearing reel 1B according to the third embodiment, by switching the connection/disconnection between the second drag mechanism 50B and the spool shaft 20 using the switching operation lever 73 of the restriction switching mechanism 70A, the drag force adjusted by the braking force adjustment unit 80 of the second drag mechanism 50B can be added or supplemented as needed.

In the third embodiment as described above, the second drag mechanism 50B is not positioned directly on the spool shaft 20. Therefore, there is no need to fix either the spool shaft 20 or the drag nut 53 against relative rotation when adjusting the drag force to be added or supplemented.

While embodiments of the claimed invention have been described above, these embodiments are presented by way of example and are not intended to limit the scope of the invention. The embodiments can be implemented in various other forms and may undergo various omissions, replacements, or modifications without departing from the spirit of the invention. The embodiments and their variations include, for example, those that can be easily conceived by those skilled in the art, those that are substantially identical, and those that fall within the scope of equivalents.

### REFERENCE SIGNS LIST

1, 1A, 1B Dual-bearing reel (Fishing reel)
2 Spool
3 Handle
4 Drag adjustment unit
10 Reel body
12A Right cover member
12B Left cover member
20 Spool shaft
30 Drive shaft
34 Drive gear
40 First drag mechanism
50, 50A, 50B Second drag mechanism
51 Main drag plate (First drag plate)
52 Drag receiving gear (Second drag plate)
52 Engagement recess
53 Drag nut (Restriction unit)
53a Gear unit
55 Lock gear
55a Gear unit
60 Restriction switching mechanism
61 Restriction-switching operation unit
62 Engagement claw
70 Adjustment mechanism
70A Restriction switching mechanism
71 Locking claw
73 Switching operation lever (Adjustment-switching operation unit)
74 Movable member
75 Connecting gear
76 Gear plate
80, 80A Braking force adjustment unit (Adjustment unit)
81 Adjustment gear
82A, 82B Drag plate
83 Nut cylindrical portion
84 Screw shaft
85 Adjustment knob
86 Retaining ring
87 Adjustment shaft
89 Adjustment knob
P1, P3 Disengaged position
P2 Engaged position
P4 Fit position
P5 Disengaged position
P6 Engaged position
X Axial direction
X1 Rightward direction
X2 Leftward direction

1. A fishing reel, comprising:
a reel body;
a handle rotatably mounted on the reel body;
a drive shaft configured to rotate integrally with the handle;
a spool rotatably supported by the reel body;
a drive gear configured to rotate integrally with the spool;
a first drag mechanism configured to restrict relative rotation between the drive shaft and the drive gear;
a spool shaft configured to rotate integrally with the spool;
a second drag mechanism configured to restrict relative rotation between the spool shaft and the reel body; and
a restriction switching mechanism configured to switch the second drag mechanism between a restricted state and a non-restricted state.

2. The fishing reel according to claim 1, wherein
the second drag mechanism includes:
a first drag plate configured to rotate integrally with the spool shaft,
a second drag plate arranged around the spool shaft and facing the first drag plate, and
a restriction unit configured to restrict relative rotation between the first and second drag plates; and
the restriction switching mechanism is configured to switch the second drag plate between a rotatable state and a non-rotatable state around the spool.

3. The fishing reel according to claim 2, wherein
the second drag plate includes an engagement recess,
the restriction switching mechanism includes:
a restriction-switching operation unit; and
an engagement claw engageable with the engagement recess;
wherein the restriction-switching operation unit is configured to engage and disengage the engagement recess and the engagement claw, so as to switch the second drag plate between a rotatable state and a non-rotatable state around the spool.

4. The fishing reel according to claim 3, wherein
the engagement recess of the second drag plate has a gear shape that is configured to prohibit a first rotation in a direction in which a fishing line is dispensed and permit a second rotation in a direction in which the fishing line is retrieved.

5. The fishing reel according to claim 1, further comprising:
an adjustment mechanism configured to adjust a restriction force applied by the second drag mechanism.

6. The fishing reel according to claim 5, wherein
the adjustment mechanism includes an adjustment-switching operation unit configured to switch between an adjustable state and a non-adjustable state.

7. The fishing reel according to claim 5, wherein
the second drag mechanism includes:
a first drag plate configured to rotate integrally with the spool shaft,
a second drag plate arranged facing the first drag plate, and
a restriction unit configured to apply a restriction force to the relative rotation between the first drag plate and the second drag plate;
wherein the adjustment mechanism includes an adjustment unit configured to adjust the restriction force applied by the restriction unit.

8. The fishing reel according to claim 7, wherein
the second drag mechanism further includes a switching device disposed in the reel body and configured to selectively connect or disconnect rotation between an outer peripheral gear of the second drag plate, the rotation of which is restricted, and a gear configured to rotate integrally with the spool shaft.

9. The fishing reel according to claim 7, wherein
the adjustment unit includes:
an adjustment knob disposed on the reel body; and
an adjustment gear arranged around the axis of the spool and configured to advance and retract in the axial direction of the spool shaft by operation of the adjustment knob so as to adjust the restriction force applied by the restriction unit.
